(19) United States
(12) Patent Application Publication
(10) Pub. No.: US 2014/0055379 A1
(43) Pub. Date: Feb. 27, 2014

(54) TOUCH ELECTRODE DEVICE

(71) Applicant: HENGHAO TECHNOLOGY CO. LTD, Taoyuan County (TW)

(72) Inventors: KUAN-YEN MA, Taoyuan County (TW); KUANG-TA CHEN, Taoyuan County (TW); Chien-Wen Lai, New Taipei City (TW)

(73) Assignee: HENGHAO TECHNOLOGY CO. LTD, Taoyuan County (TW)

(21) Appl. No.: 13/677,083

(22) Filed: Nov. 14, 2012

(30) Foreign Application Priority Data
Aug. 23, 2012 (TW) 101130689

(51) Int. Cl. G06F 3/0488

(52) U.S. Cl. CPC G06F 3/0488
USPC 345/173

(57) ABSTRACT

A touch electrode device includes a substrate and at least one transparent electrode layer. The transparent electrode layer is disposed above a surface of the substrate. The transparent electrode layer includes a plurality of metal nanowires.

### CROSS-REFERENCE TO RELATED APPLICATIONS

This application claims priority to Taiwan Patent Application No. 101130689, filed on Aug. 23, 2012, the entire contents of which are hereby incorporated by reference.

### BACKGROUND OF THE INVENTION

1. Field of the Invention

The present invention generally relates to a touch electrode device, and more particularly to a flexible touch electrode device with metal nanowires.

2. Description of Related Art

A touch screen is an input/output device that adopts sensing technology and display technology, and has been widely employed in electronic devices such as portable or hand-held electronic devices.

A capacitor-based touch panel is a commonly used touch panel that utilizes capacitive coupling effect to detect touch position. Specifically, capacitance corresponding to the touch position changes and is thus detected, when a finger touches a surface of the touch panel.

FIG. 1A shows a top view of a conventional touch panel, and FIG. 1B shows a cross-sectional view along a section line 1B-1B′ in FIG. 1A. Specifically, first electrodes 12 are formed on a top surface of a substrate 10, and second electrodes 14 are formed on a bottom surface of the substrate 10. The first electrodes 12 and the second electrodes 14 may be substantially orthogonal to each other.

The first electrodes 12 and the second electrodes 14 of the conventional touch panel as discussed above are commonly made up of transparent conductive material such as indium tin oxide (ITO). The ITO is formed by using a complex process. Moreover, as the ITO fractures when it is bent, the ITO thus cannot afford to make a flexible touch panel.

For the reason that the conventional touch panel requires complex manufacturing process and cannot afford to make a flexible touch panel, a need has thus arisen to propose a novel touch electrode device to overcome disadvantages of the conventional touch panel.

### SUMMARY OF THE INVENTION

In view of the foregoing, it is an object of the embodiment of the present invention to provide a touch electrode device for manufacturing a flexible touch electrode device, or simplifying a process by directly performing photolithography.

According to one embodiment, a touch electrode device includes a substrate and at least one transparent electrode layer. The transparent electrode layer is directly or indirectly disposed on a surface of the substrate, and the transparent electrode layer includes a plurality of metal nanowires.

### BRIEF DESCRIPTION OF THE DRAWINGS

FIG. 1A shows a top view of a conventional touch panel;

FIG. 1B shows a cross-sectional view along a section line 1B-1B′ in FIG. 1A;

FIG. 2A shows a top view of a touch electrode device according one embodiment of the present invention;

FIG. 2B shows a cross-sectional view along a section line 2-2′ in FIG. 2A;

FIG. 2C shows a cross-sectional view of a modified touch electrode device;

FIG. 3A shows a top view of a touch electrode device with a single-side double-layer structure;

FIG. 3B shows a cross-sectional view along a section line 3-3′ in FIG. 3A;

FIG. 4A shows a top view of a touch electrode device with a double-side structure;

FIG. 4B shows a cross-sectional view along a section line 4-4′ in FIG. 4A;

FIG. 5A and FIG. 5B show cross-sectional views of touch displays adopting the embodiment; and

FIG. 6 shows a cross-sectional view of a touch panel adopting the embodiment.

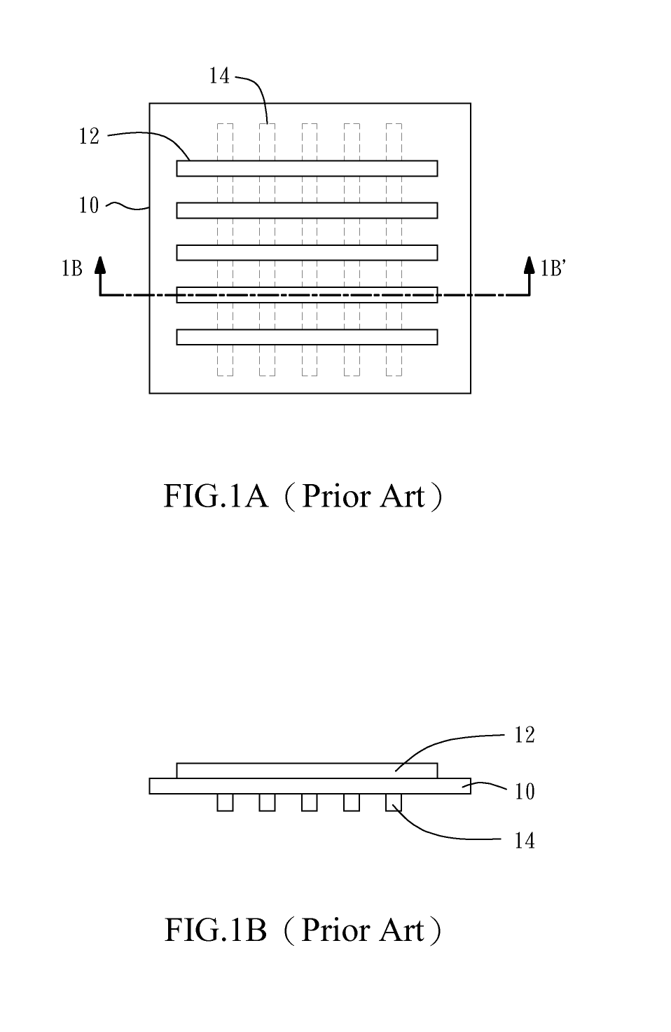

### DETAILED DESCRIPTION OF THE INVENTION

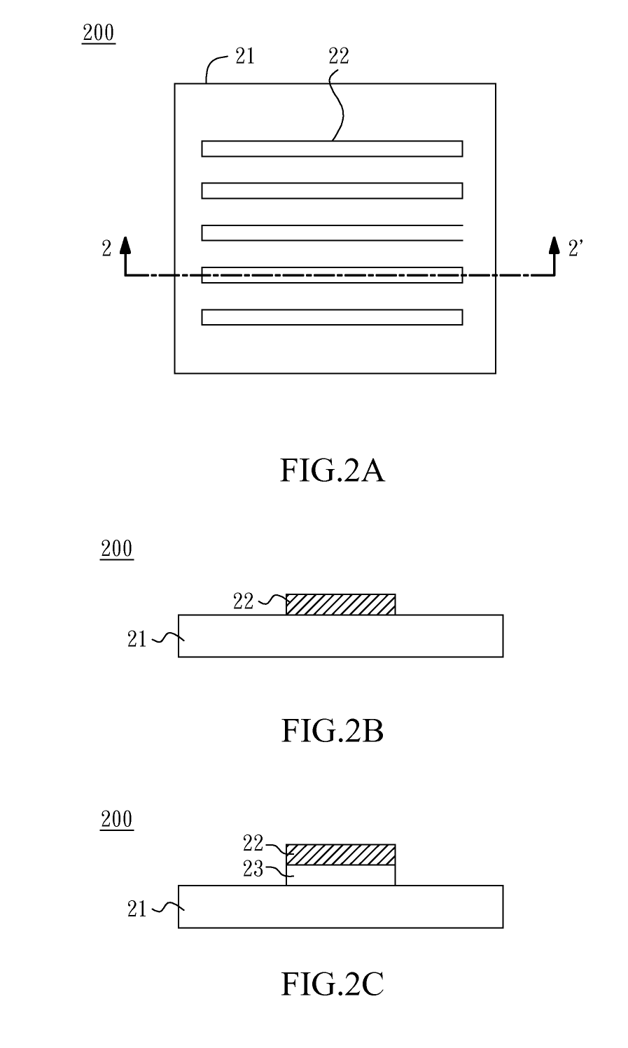

FIG. 2A shows a top view of a touch electrode device 200 according one embodiment of the present invention, and FIG. 2B shows a cross-sectional view along a section line 2-2′ in FIG. 2A. Only composing elements pertinent to the embodiment are shown in the figures. The touch electrode device 200 of the embodiment includes a substrate 21 and at least one transparent electrode layer 22, which may, but not necessarily, be disposed on a surface (e.g., a top surface) of the substrate 21. According to one aspect of the embodiment, the transparent electrode layer 22 includes plural metal nanowires, such as silver nanowires, with a nano-grade diameter (e.g., a diameter of some nanometers to hundreds of nanometers). The metal nanowires are fixed, by plastic material e.g., resin), in the transparent electrode layer 22. As the metal nanowires are too thin to be observed by human eyes, the transparent electrode layer 22 made of the metal nanowires thus has high transmittance, and overall thickness of the touch electrode device 200 may also be reduced. The metal nanowires are flatly distributed, and the transparent electrode layer 22 made of the metal nanowires therefore has an isotropic conductivity, which substantially invariant with respect to direction.

According to another aspect of the embodiment, the transparent electrode layer 22 may also include photoresistive material (e.g., acrylics), which can be patterned by a photolithographic process. Compared with a conventional process using ITO for forming an electrode layer, the transparent electrode layer 22 of the embodiment may be directly subjected to a photolithographic process, thereby simplifying the overall process to reduce cost.

According to aspects of the embodiment as discussed above, in one embodiment, the transparent electrode layer 22 including metal nanowires and photosensitive material is first prepared. When manufacturing the touch electrode layer 200, the prepared transparent electrode layer 22 is coated on the surface of the substrate 21, which is then subjected directly to a photolithographic process to result in the patterned transparent electrode layer 22 with required pattern.

In the embodiment, the substrate 21 may include, for example, glass, polyester or flexible material. As the metal nanowires mentioned above are very thin in diameter, the metal nanowires may accompany the substrate 21 to form a flexible touch electrode device 200. To the contrary, indium tin oxide (ITO), which is conventionally used as transparent conductive material, suffers from fracture and therefore ITO is difficultly adapted to make a flexible touch electrode device. Alternatively speaking, ITO has flexibility substantially lower than the transparent electrode 22 including metal nanowires as disclosed in the embodiment.

FIG. 2C shows a cross-sectional view of a modified touch electrode device 200, which further includes an insulation layer 23 disposed between the substrate 21 and the transparent electrode layer 22, such that the transparent electrode layer 22 becomes indirectly disposed on the surface of the substrate 21. In one embodiment, the insulation layer 23 may include photoresistive material, which may then be patterned, along with the transparent electrode layer 22 via photolithographic process.

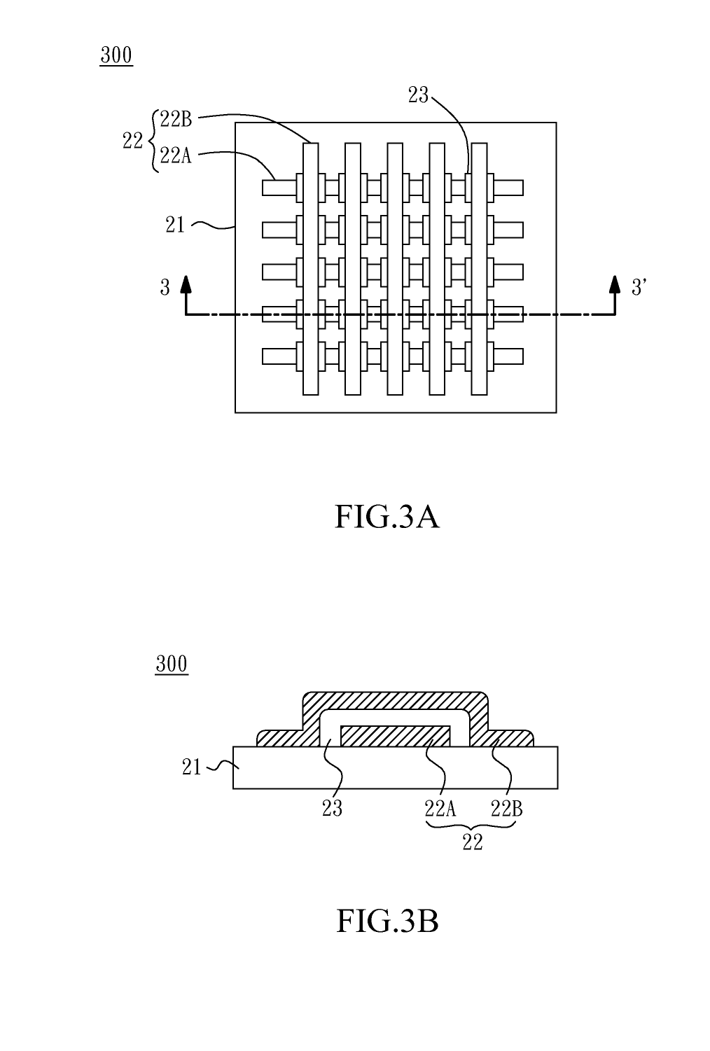

The touch electrode device 200 illustrated in FIG. 2B and FIG. 2C adopts a single-side single-layer structure, that is, a single transparent electrode layer 22 is disposed on a single surface of the substrate 21. The embodiment, however, may adopt other structures, for example, a single-side double-layer structure or a double-side structure. FIG. 3A shows a top view of a touch electrode device 300 with a single-side double-layer structure, and FIG. 3B shows a cross-sectional view along a section line 3-3′ in FIG. 3A. Specifically, a first transparent electrode layer 22A and a second transparent electrode layer 22B are formed in sequence on a surface of the substrate 21, and the first transparent electrode layer 22A and the second transparent electrode layer 22B are insulated from each other by an insulation layer 23. The first/second transparent electrode layer 22A/22B may include metal nanowires. Alternatively, the first/second transparent electrode layer 22A/22B may partially include other material such as indium, tin oxide (ITO).

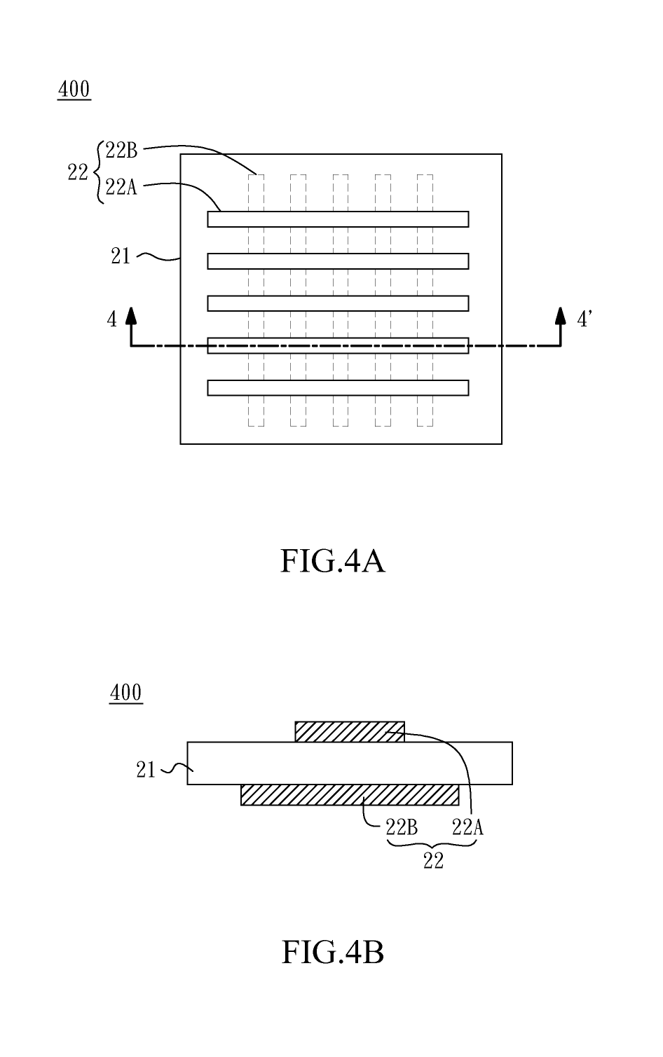

FIG. 4A shows a top view of a touch electrode device 400 with a double-side structure, and FIG. 4B shows a cross-sectional view along a section line 4-4′ in FIG. 4A. Specifically, the first transparent electrode layer 22A and the second transparent electrode layer 22B are formed on opposite surfaces of the substrate 21, respectively. The first/second transparent electrode layer 22A/22B may include metal nanowires. Alternatively, the first/second transparent electrode layer 22A/22B may partially include other material such as indium tin oxide (ITO).

Compared with the conventional touch electrode devices, the touch electrode device 200/300/400 of the embodiment includes the transparent electrode layer 22 having metal nanowires, therefore making it flexible. The touch electrode device 200/300/400 discussed above may be adapted to a variety of touch structures (particularly capacitor-based touch structures), such as touch panels or touch display panels, to show advantages mentioned above by way of some examples demonstrated below.

FIG. 5A shows a cross-sectional view of a touch display 3 adopting the embodiment. For better understanding, only composing elements pertinent to the touch display 3 are shown. As shown in FIG. 5A, the touch display 3 is formed by stacking a display panel 301 and a touch panel 310. Specifically, the display panel 301 primarily includes a liquid crystal (LC) layer 31 and a color filter (CF) 32. The touch panel 310 primarily includes a polarizer 33 and a transparent electrode layer 22, which is disposed on a top surface of the polarizer 33, and the polarizer 33 acts as the substrate 21 in FIG. 2A through FIG. 4B. The transparent electrode layer 22 of FIG. 5A may include a single transparent electrode sub-layer or multiple transparent electrode sub-layers (e.g., the first transparent electrode layer 22A and the second transparent electrode layer 22B mentioned above). The display panel 301 in the exemplary embodiment may be a flexible display panel 301, which may accompany a flexible touch panel 310 to from a flexible touch display 3.

FIG. 5B shows a cross-sectional view of another touch display 3′ adopting the embodiment. The present embodiment differs from FIG. 5A on difference that the transparent electrode layer 22 of FIG. 5B is disposed on a bottom surface of the polarizer 33.

In another embodiment, still referring to FIG. 5B, the transparent electrode layer 22 is disposed on a top surface of the color filter (CF) 32, which acts as the substrate 21 in FIG. 2A through FIG. 4B.

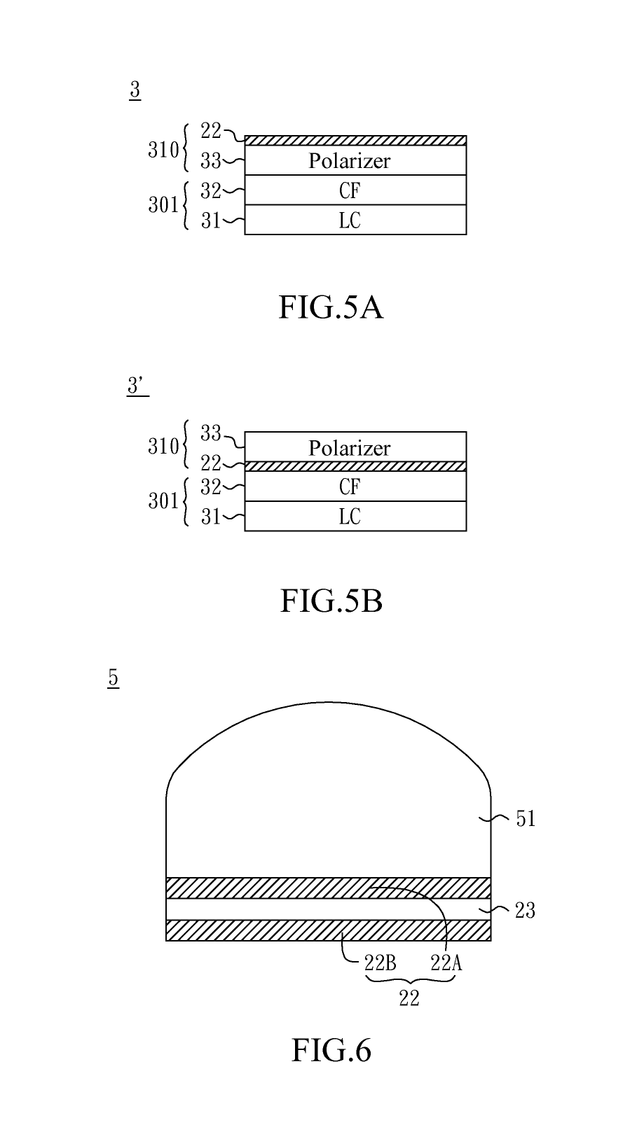

FIG. 6 shows a cross-sectional view of a touch panel 5 adopting the embodiment. In the present exemplary embodiment, the first transparent electrode layer 22A, the insulation layer 23 and the second transparent electrode layer 22B are disposed on a bottom surface of a cover glass 51 in sequence. The cover glass 51 acts as the substrate 21 in FIG. 2A through FIG. 4B, and the cover glass 51 may have a two-dimensional or three-dimensional profile, which may be applied to a two-dimensional or a three-dimensional touch display, respectively.

The touch displays 3, 3′ and 5 illustrated above are just some exemplary applications adopting the touch electrode devices 200, 300 and 400 according to the embodiment of the present invention. It is appreciated that the transparent electrode layer 22 may be applied to replace the conventional electrode layer in a variety of flexible or non-flexible touch structures.

Although specific embodiments have been illustrated and described, it will be appreciated by those skilled in the art that various modifications may be made without departing from the scope of the present invention, which is intended to be limited solely by the appended claims.

What is claimed is:

1. A touch electrode device, comprising:
a substrate; and
at least one transparent electrode layer disposed above a surface of the substrate, the transparent electrode layer including a plurality of metal nanowires.

2. The device of claim 1, further comprising an insulation layer disposed between the transparent electrode layer and the substrate.

3. The device of claim 2, wherein the insulation layer comprises insulation material.

4. The device of claim 2, wherein the at least one transparent electrode layer comprises a first transparent electrode layer and a second transparent electrode layer disposed above a same surface of the substrate; and the insulation layer is disposed between the first transparent electrode layer and the second transparent electrode layer for electrical insulation therebetween.

5. The device of claim 1, wherein the at least one transparent electrode layer comprises a first transparent electrode layer and a second transparent electrode layer disposed on opposite surfaces of the substrate, respectively.

6. The device of claim 1, the metal nanowires comprise silver.

7. The device of claim 1, wherein the metal nanowire has a diameter of some nanometers to hundreds of nanometers.

8. The device of claim 1, wherein the transparent electrode layer further comprises plastic material for fixing the metal nanowires in the transparent electrode layer.

9. The device of claim 1, wherein the metal nanowires are flatly distributed.

10. The device of claim 1, wherein the substrate comprises flexible material.

11. The device of claim 1, wherein the transparent electrode layer further comprises photo resistive material.

12. The device of claim 2, wherein the insulation layer comprises photoresistive material.

13. The device of claim 1, wherein the substrate comprises a polarizer, and the transparent electrode layer is disposed on a top surface or a bottom surface of the polarizer.

14. The device of claim 1, wherein the substrate comprises a color filter, and the transparent electrode layer is disposed on a top surface of the color filter.

15. The device of claim 2, wherein the substrate comprises a cover glass, and the at least one transparent electrode layer is disposed on a bottom surface of the cover glass.

16. The device of claim 15, wherein the at least one transparent electrode layer comprises a first transparent electrode layer and a second transparent electrode layer, wherein the first transparent electrode layer, the insulation layer and the second transparent electrode layer are disposed on the bottom surface of the cover glass in sequence.
